(19) United States
(12) Patent Application Publication
(10) Pub. No.: US 2010/0066664 A1
(43) Pub. Date: Mar. 18, 2010

(54) WRIST-WORN INPUT APPARATUS AND METHOD

(76) Inventors: Yong-Ki Son, Daejon (KR); John Sunwoo, Daejon (KR); Ji-Eun Kim, Daejon (KR); Dong-Woo Lee, Daejon (KR); Il-Yeon Cho, Daejon (KR)

Correspondence Address: LADAS & PARRY LLP, 224 SOUTH MICHIGAN AVENUE, SUITE 1600, CHICAGO, IL, 60604, US

(21) Appl. No.: 12/516,856

(22) PCT Filed: Dec. 5, 2007
(86) PCT No.: PCT/KR07/06288

§ 371 Date: May 29, 2009

(30) Foreign Application Priority Data
Dec. 8, 2006 (KR) 10-2006-0125141

(51) Int. Cl. G09G 5/00

(52) U.S. Cl. 345/156

(57) ABSTRACT

Provided are a wrist-worn input apparatus and method. The apparatus and method can segment meaningful hand gestures using a vibration sound generated by a finger tapping and can issue commands corresponding to the recognized hand gestures, enabling the user to easily input commands to electronic devices.

### TECHNICAL FIELD

The present invention relates to a wrist-worn input apparatus and method; and, more particularly, to a wrist-worn input apparatus and method, which can segment meaningful hand gestures using a vibration sound generated by a finger tapping and can issue commands corresponding to the recognized hand gestures, enabling the user to easily input commands to elect This work was supported by the IT R&D program for MIC/IITA [2005-S-065-02, “Development of Wearable Personal Station”].

### BACKGROUND ART

After the introduction of computers, their applications continue to diversify to an increasing number of fields. Also, most personal electronic devices are becoming more intelligent with computing abilities. Examples of input devices for inputting commands, data, etc. include keyboard, mouse, touch pad, button, and various other devices. Such input devices for computers and computer-based electronic devices have not changed much since the introduction of the computer. Therefore, users experience inconvenience when using computers and computer-based electronic devices that have more and more functions as computing capabilities increase.

Thus, users require simple and intuitive user interfaces. Specifically, because computing functions are gradually becoming more intuitive, users want input devices that do not require them to learn a specific command language or operating method. This tendency is manifested in the transition from letter and character-based user interfaces to graphic user interfaces (GUI) employing icons and windows.

A method of using a typical keyboard allows inputting of commands or data within a space in which the keyboard is placed, and the introduction of the mouse has provided a device suitable for use with a GUI. As user interfaces become more user-friendly, touch pads and other devices for basic data input are being developed in suitable configurations.

Due to technological advancements, input devices of many types, such as controller gloves, movement sensing mice and pens, and vision-based movement sensing systems, have recently been developed to replace the traditional input devices.

Controller gloves include various sensors attached thereon to detect a user's movements and convert the movements to commands. Such controller gloves are inconvenient in that a user must wear the glove whenever the user wishes to input commands. It is difficult to constantly wear such an input device.

An air mouse or movement sensing pen has a built-in sensor that perceives a user's suspended movement of the device to process commands. Such an input device must always be carried by a user in a pocket, bag, etc., and also inconvenient in that it must be grasped by a user to be used, thus constraining the user's grasping hand.

While a vision-based movement sensing system senses movement through image movement detection, it is sensitive to light, has a large algorithmic load, and is difficult to use in an outdoor environment.

Korean Patent Application No. 10-2003-7015682 discloses a user input apparatus, which has a band with a sensing surface that contacts a user's wrist and detects a variety of command inputs. However, Korean Patent Application No. 10-2003-7015682 fails to provide a specific method by which the user input apparatus is connected to an external device to be controlled. Thus, there is a limitation in connecting the apparatus to the device.

As described above, in the conventional user input technologies, those that employ hand/wrist-worn devices are difficult to always wear, those that employ hand-held devices are difficult to hold and simultaneously input commands with, and those that employ vision or similar devices installed in a user environment are restricted to use only within the proximity of the installed location.

Particularly in the case of movement sensing devices, there is yet no suitable method of distinguishing between different types of movements. Also, while technology that connects to proximate apparatuses for controlling devices such as computers and computing electronic devices includes human medium communication technology that is being developed, this technology is not yet in use.

### DISCLOSURE OF INVENTION

### Technical Problem

An embodiment of the present invention is directed to providing a wrist-worn input apparatus and method, which can segment meaningful hand gestures using a finger tapping as a gesture segmentation cue and issue commands corresponding to the hand gestures, enabling the user to easily input commands to electronic devices.

Another embodiment of the present invention is directed to providing a wrist-worn input apparatus and method, which can use vibrations transmitted from an electronic device to perform network settings, in order to facilitate the performing of settings for a network between devices to be used.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a wrist-worn input apparatus, including: a vibration signal amplifying/measuring unit for measuring a vibration sound transmitted through a user's bodily vibrations, and amplifying a vibration signal of the measured vibration sound; a movement signal measuring unit for measuring a movement signal of a hand gesture of the user; and a signal processing unit for analyzing the vibration signal transferred from the vibration signal amplifying/measuring unit and the movement signal measured by the movement signal measurer, and performing a command corresponding to the analysis results.

In accordance with another aspect of the present invention, there is provided a method for inputting a user command with a wrist worn apparatus, including the steps of: measuring a vibration sound transferred through a user's bodily vibrations, and amplifying a vibration signal of the measured vibration sound; measuring a movement signal of a hand gesture of the user; and processing signals through analyzing the vibration signal amplified in the step of measuring the vibration sound and amplifying the vibration signal and the movement signal measured in the step of measuring the movement signal, and performing a command corresponding to results of the analysis.

### ADVANTAGEOUS EFFECTS

The apparatus and method in accordance with the present invention amplify finger contact sound, i.e., vibrations generated by a finger tapping, check the starting point of a user's hand gesture command using the finger tapping and recognize a user command through a movement of the user detected from the checked starting point, so that the user's commands can be input to an electronic device through intuitive movements of the user, while allowing the user to comfortably wear the device like a wristwatch or wristband for a prolonged duration.

In addition, the apparatus and method in accordance with the present invention provide easy access to devices by allowing a user, through directional movement, to make connection settings with computers and computer-based electronic devices.

Furthermore, because the apparatus and method in accordance with the present invention use transmitted vibrations, the apparatuses can be completely sealed and thus made for use in underwater or other environments with moisture or other potentially damaging elements.

### BRIEF DESCRIPTION OF THE DRAWINGS

FIG. 1 is a diagram showing a user wearing a wrist-worn input apparatus in accordance with an embodiment of the present invention.

FIG. 2 is a block diagram showing a wrist-worn input apparatus in accordance with an embodiment of the present invention.

FIG. 3 is a diagram showing a method of connecting a wrist-worn input apparatus and an electronic device in accordance with an embodiment of the present invention.

FIG. 4 is a diagram showing a method of connecting a wrist-worn input apparatus and an electronic device in accordance with another embodiment of the present invention.

### BEST MODE FOR CARRYING OUT THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

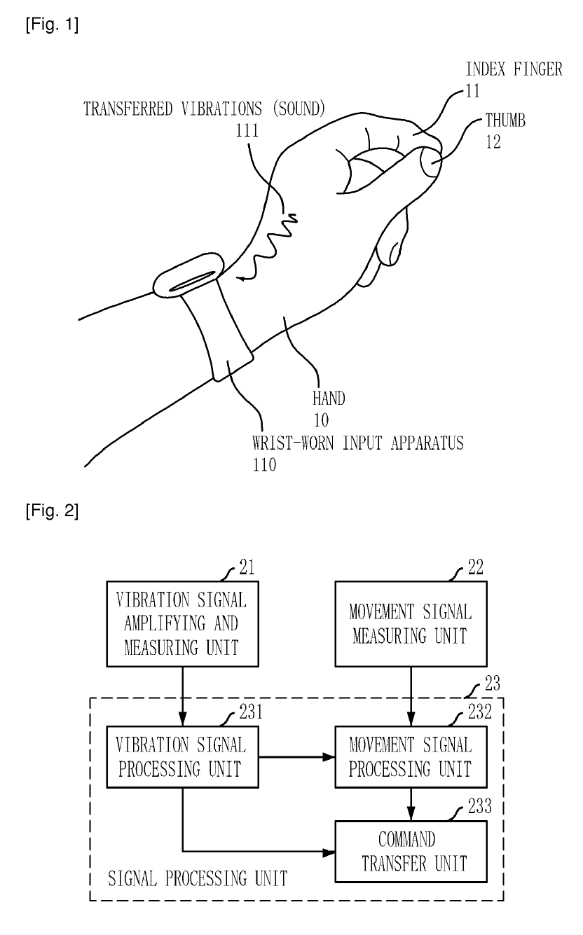

FIG. 1 is a diagram showing a user wearing a wrist-worn input apparatus in accordance with an embodiment of the present invention.

Referring to FIG. 1, a wrist-worn input apparatus 110 in accordance with the present invention can recognize a user's hand gesture commands using a finger tapping as a gesture segmentation cue. When a user moves a hand 10 on which the wrist-worn input apparatus 110 is worn, the wrist-worn input apparatus 110 recognizes the movement of the hand 10 and inputs the recognized results to a computer or an electronic device as a command or other data. The wrist-worn input apparatus 110 may have the outer appearance of a wristwatch or a wristband.

A method for sensing a tapping sound between two fingers will be described in the following. When a user's hand 10 is moved to the left and two fingers of the index finger 11 and the thumb 12 are simultaneously put into contact, the wrist-worn input apparatus 110 amplifies the tapping sound between two fingers, i.e., the transferred vibrations 111, detects the amplified tapping sound, and senses the starting point of the user-issued hand gesture command.

When the wrist-worn input apparatus 110 senses the starting point of the hand gesture command, the proceeding hand gesture, i.e., command, is analyzed to determine the user command. Also, the wrist-worn input apparatus 110 inputs the determined user command to a computer or electronic device.

Thus, the wrist-worn input apparatus 110 can determine commands that are inputted by a user through hands-free movement without having to hold the input apparatus in the user's hand.

FIG. 2 is a block diagram illustrating a wrist-worn input apparatus in accordance with an embodiment of the present invention.

Referring to FIG. 2, the wrist-worn input apparatus 110 in accordance with the present invention includes a vibration signal amplifying/measuring unit 21, a movement signal measuring unit 22, and a signal processing unit 23. The signal processing unit 23 includes a vibration signal processing unit 231, a movement signal processing unit 232, and a command transferring unit 233.

The vibration signal amplifying/measuring unit 21 measures the vibration sound transferred through bodily vibrations of a user, and amplifies the measured vibration signals. The vibration signal amplifying/measuring unit 21 relays the amplified vibration signal to the signal processor 23. The vibration sound includes vibration sounds from contact between fingers and a vibration sound generated by a vibrating member of an external electronic device.

The movement signal measuring unit 22 measures a movement signal of a user's hand gesture. The gesture signal measuring unit 22 may include a sensor, e.g., a tri-axial acceleration sensor, a gyro sensor, capable of sensing movement, in order to measure a hand movement signal. The movement signal measuring unit 22 relays the measured movement signal to the signal processing unit 23.

The signal processing unit 23 uses the vibration signal relayed from the vibration signal amplifying/measuring unit 21 to check the starting point of the user's hand gesture command, analyzes the movement signal measured by the movement signal measuring unit 22 from the checked starting point of the user's hand gesture command, and recognizes a user hand gesture command according to the results of the analysis. Also, the signal processing unit 23 analyzes the vibration signal and movement signal transferred respectively from the vibration signal amplifying/measuring unit 21 and the movement signal measuring unit 22, and relays a command corresponding to the analysis results to an internal/external device.

To describe the signal processing unit 23 in more detail, the vibration signal processing unit 231 detects a finger tapping sound, i.e., contact vibration, from the vibration signal relayed from the vibration signal amplifying/measuring unit 21, and analyzes the detected vibration signal. The vibration signal processing unit 231 also relays the analysis results to the movement signal processing unit 232 and the command transferring unit 233. The finger tapping sound may apply to contact between any of the fingers and thumbs.

The movement signal processing unit 232 checks the starting point of a user's hand gesture command on the basis of the analysis results relayed from the vibration signal processing unit 231. The movement signal processing unit 232 analyzes the movement signal measured by the movement signal measuring unit 22 from the checked starting point of the user's hand gesture command, and recognizes the user's hand gesture command corresponding to the analysis results. The movement signal processing unit 232 also generates a hand gesture command corresponding to the recognized hand gesture command, and relays the generated hand gesture command to the command transferring unit 233.

The command transferring unit 233 may check the analysis results received from the vibration signal processing unit 231, and relay the user's hand gesture command signal received from the movement signal processing unit 232 to an internal or external device, through a wired or wireless communication interface. The command transferring unit 233 includes a wired or wireless communication interface capable of relaying such command signals. The command transferring unit 233 may be connected to another electronic device via the wired or wireless communication interface.

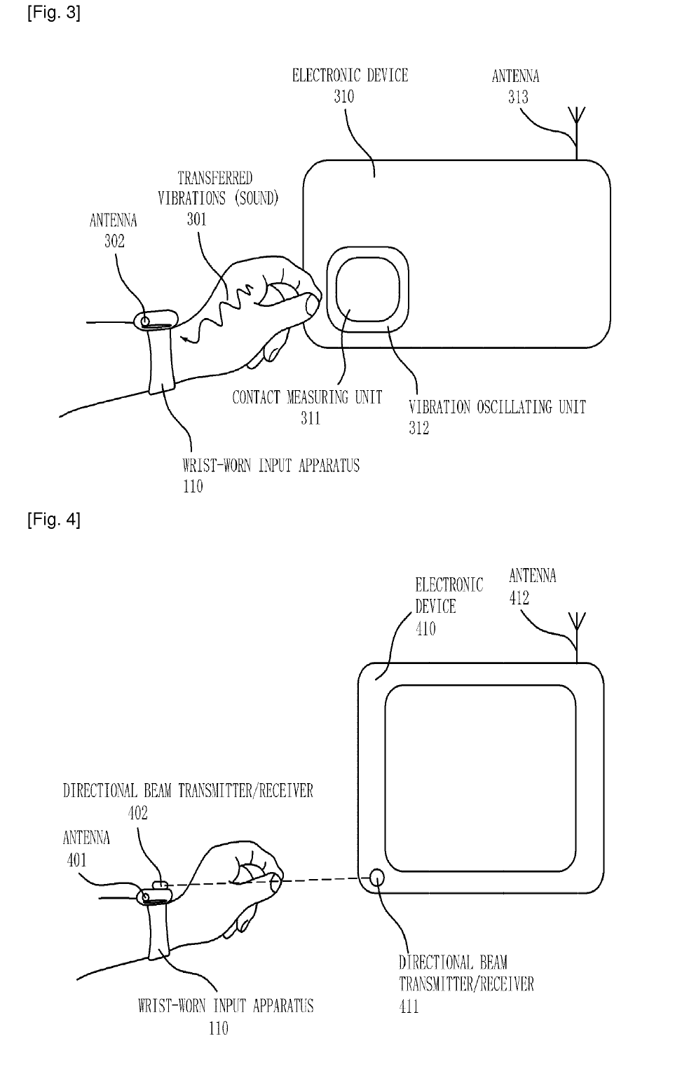

The signal processing unit 23 further includes a network connection setting unit (not shown in FIG. 2) for setting up a connection between external electronic devices 310 and 410, based on the analysis results relayed from the vibration signal processing unit 231. Below, a description of the network connection setting unit will be given with reference to FIGS. 3 and 4.

The vibration signal processing unit 231, the movement signal processing unit 232, and the command transferring unit 233 may be combined into one processor.

Below, the process of perceiving a user's hand gestures will be described in further detail.

The wrist-worn input apparatus 110 may detect a user's hand gesture and perceive the detected movement as a corresponding command. For example, when a user's hand wearing the wrist-worn input apparatus is moved to the right, the movement may be interpreted as the command, “next song”. Such commands for movements must be predetermined, and the predetermining of commands may be preset by a user or by the manufacturer. For example, if the vibration signal amplifying/measuring unit 21 receives a command starting point, i.e., finger tapping sound, from a user while the user is listening to music, the movement signal measuring unit 22 perceives a movement to the right according to the movement of the hand. Then, the signal processing unit 23 may analyze the contact sound and the movement to the right according to the movement of the hand, and relay a “next song” command, which is analyzed as corresponding to the movement to the right, to an internal or external device.

In order to discern an arbitrary hand gesture from a user-intended command-inducing hand gesture, the contacting or snapping of fingers and the vibrations thereof may be used as a precursor to a command input. Bone-conduction vibration denotes a vibration applied to the body that is transmitted through bones or skin elsewhere. Bone-conduction vibration induced by tapping two fingers are transmitted through the finger bones or skin to the wrist-worn input device 110 and detected as a vibration signal.

Thus, user-intended, i.e., command, movements may be distinguished from arbitrary hand gestures through user-intended cue such as a tapping of the fingers. As finger tapping sounds, i.e., vibrations, are created from consciously performed hand gestures, such hand motions can be distinguished from other arbitrary hand gestures. Thus, the finger tapping sounds as a command signal are distinguishable from sound generated by drumming fingers on other objects or the sound of grasping an object, for example. When performing a cue action such as a tapping of fingers for issuing a command, there is no need to deviate much from everyday hand motions, so that learning such a command language is easy. In addition, it is easier to distinguish repetitive hand motions. For example, it not easy to distinguish between an arbitrary movement of a hand twice to the right and a hand gesture command, in which a hand is moved to the right, performed twice. However, the distinction can be clearly made when the tapping of the fingers is employed.

FIG. 3 is a diagram showing a method of connecting a wrist-worn input apparatus and an electronic device in accordance with an embodiment of the present invention.

Referring to FIG. 3, a method of setting a network connection for transferring data between the wrist-worn input apparatus 110 and an electronic device 310 using bodily vibrations will be described.

The electronic device 310 includes a button-type contact measuring unit 311 and a vibration oscillating unit 312.

When a user contacts the button type contact measuring unit 311 provided on the electronic device 310 that the user wishes to use, the vibration oscillating unit 312 generates vibrations corresponding to connection setting data of the electronic device 310. The transferred vibrations 301 are transferred through the fingers to the wrist-worn input apparatus 110.

Then, the transferred vibrations 301 are amplified and measured by the vibration signal amplifying/measuring unit 21, and the measured results are transferred to the vibration signal processing unit 231. The vibration signal processing unit 231 analyzes the measured results and uses the analysis as data for performing the corresponding connection setting.

The connection between the respective devices is made possible through a communication interface such as wireless LAN or Bluetooth technology. Although the above connection can be similarly achieved using near-field communication (NFC) or Infrared Data Association (IrDA) standards, the LAN and Bluetooth connecting standards are suitable for direct and simple setting connections using simple hardware because data is transferred through vibration.

FIG. 4 is a diagram showing a method of connecting a wrist-worn input apparatus and an electronic device in accordance with another embodiment of the present invention.

A communication interface for connection settings may employ directional beams such as IrDA, ultrasound, laser, and other beams. When a user performs a movement such as grasping with the fingers in a direction toward the electronic device 410 that the user wants to connect with and use, a beam of a predetermined pattern is emitted from a directional beam transmitter/receiver 402 of the wrist-worn input apparatus 110 and reaches the electronic device 410. The electronic device 410 receives the beam from the directional beam transmitter/receiver 402, and the device connection setting data is created.

The created data is received by the directional beam transmitter/receiver 402 and is used for the connection settings between the devices, and a connection between the devices such as the communication interface employing wireless LAN or Bluetooth standards described in FIG. 3 can be achieved. Through such devices, a movement such as directionally grasping with the fingers signifying “select” can be performed, allowing a user to directionally select a device.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

The present application contains subject matter related to Korean Patent Application No. 2006-0125141, filed in the Korean Intellectual Property Office on Dec. 8, 2006, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A wrist-worn input apparatus, comprising:
a vibration signal amplifying/measuring unit for measuring a vibration sound transmitted through a user's body, and amplifying a measured vibration signal;
a movement signal measuring unit for measuring the user's hand gesture; and
a signal processing unit for analyzing the vibration signal transferred from the vibration signal amplifying/measuring unit and the movement signal measured by the movement signal measurer, and performing a command corresponding to the recognized results.

2. The wrist-worn input apparatus of claim 1, wherein the vibration signal amplifying/measuring unit receives the vibration sound that is the finger tapping sound transmitted through the user's body, measures the vibration sound, and amplifies the measured vibration sound.

3. The wrist-worn input apparatus of claim 1, wherein the vibration signal amplifying/measuring unit receives the vibration sound generated by a vibrating member of an external electronic device through the user's body, measures the vibration sound, and amplifies the measured vibration sound.

4. The wrist-worn input apparatus of claim 1, wherein the signal processing unit includes:
a vibration signal processing unit for detecting a vibration signal from vibration signals corresponding to a finger tapping sound, which is a vibration transferred from the vibration signal amplifying/measuring unit, and analyzing the detected vibration signal;
a movement signal processing unit for checking a starting point of a hand gesture command of the user, based on results of the analysis from the vibration signal processing unit, analyzing the movement signal measured by the movement signal measuring unit from the starting point of the checked hand gesture command of the user, recognizing the hand gesture command of the user corresponding to results of the analysis of the movement signal, and generating a hand gesture command signal; and
a command transferring unit for transferring the hand gesture command signal of the user from the movement signal processing unit through a wired/wireless communication interface to the external electronic device, according to the results of the analysis from the vibration signal processing unit.

5. The wrist-worn input apparatus of claim 4, wherein the signal processing unit further includes a network connection setting unit for setting a connection with the external electronic device, based on the results of the analysis from the vibration signal processing unit.

6. The wrist-worn input apparatus of claim 5, wherein the network connection setting unit includes a directional beam transmitter/receiver for setting the connection by emitting a beam of a predetermined pattern with device connection setting data to the external electronic device.

7. A method for inputting a user command with a wrist worn apparatus, comprising the steps of:
measuring a vibration sound transferred through a user's bodily vibrations, and amplifying a vibration signal of the measured vibration sound;
measuring a movement signal of a hand gesture of the user; and
processing signals through analyzing the vibration signal amplified in the step of measuring the vibration sound and amplifying the vibration signal and the movement signal measured in the step of measuring the movement signal, and performing a command corresponding to results of the analysis.

8. The method of claim 7, wherein the step of measuring the vibration sound and amplifying the vibration signal includes the steps of:
receiving the vibration sound of a finger tapping sound through the user's bodily vibrations;
measuring the vibration sound; and
amplifying the measured vibration sound.

9. The method of claim 7, wherein the step of measuring the vibration sound and amplifying the vibration signal includes the steps of:
receiving the vibration sound that is generated by a vibration generator of an external electronic device through the user's bodily vibrations;
measuring the vibration sound; and
amplifying the measured vibration sound.

10. The method of claim 7, wherein the step of processing the signals includes the steps of:
processing a vibration signal through detecting a vibration signal from vibration signals amplified in the step of measuring the vibration sound and amplifying the vibration signal that corresponds to a finger tapping sound or contact vibration, and analyzing the detected vibration signal;
processing a movement signal through checking a starting point of a hand gesture command of the user based on results of the analysis from the step of processing the vibration signal, analyzing the movement signal measured in the step of measuring the movement signal from the starting point of the checked hand gesture command of the user, recognizing the hand gesture command of the user corresponding to results of the analysis of the movement signal, and generating a hand gesture command signal; and
transferring the hand gesture command signal of the user generated in the step of processing the movement signal through a wired/wireless communication interface to an external electronic device, according to the results of the analysis from the step of processing the vibration signal.

11. The method of claim 10, wherein the step of processing the signals further includes the step of:
setting a network connection with the external electronic device, based on the results of the analysis in the step of processing the vibration signal.

12. The method of claim 11, wherein the step of setting the network connection includes the step of:
using a directional beam transmitter/receiver to emit a beam of a predetermined pattern with device connection setting data to the external electronic device, thereby setting the network connection.
